(19) United States
(12) Patent Application Publication
(10) Pub. No.: US 2011/0069862 A1
(43) Pub. Date: Mar. 24, 2011

(54) Electromagnetic Imaging Analyser

(75) Inventors: Jiri Krizek, East Sussex (GB); Jan Krizek, East Sussex (GB)

(73) Assignee: VACUUM SYSTEMS LTD, East Sussex (GB)

(21) Appl. No.: 12/865,629

(22) PCT Filed: Jan. 30, 2009
(86) PCT No.: PCT/GB09/50090

§ 371 Date: Nov. 22, 2010

(30) Foreign Application Priority Data
Jan. 30, 2008 (GB) 08016636

(51) Int. Cl. G06K 9/00

(52) U.S. Cl. 382/100

(57) ABSTRACT

A particle spectrometer, operable to produce an image of a particle from an emitting or transmitting surface comprising emitting or transmitting means for said particles; means for limiting said particles according to predetermined criteria; an electromagnetic imaging analyser; selection means for selecting said particles for transmission into said spectrometer, said selection dependent on the electrostatic charge or magnetic moment of said particles, wherein said analyser includes at least two pairs of object and image planes, and wherein a first pair of said at least two pairs of object and image planes relate to a detector, which images particle distributions according to analysis criteria, a second pair of said at least two pairs of object and image planes relates to energy selection, said electromagnetic imaging analyser capable of producing at least one image of said surface, wherein each image is tuned to a selected energy range and wherein any plurality of such images are produced simultaneously.

The present invention relates to a particle energy analyser, in particular a particle energy analyser including features of a photo-electron spectroscope and a microscope.

Particle energy analysers in general are based on the principles of Einstein's photo-electric effect, and many examples of such devices are in the public domain. Spectrometers in particular are used to investigation the composition of samples and are further used to investigate the distribution of such composition over sample surfaces because the energy of particles emitted from a sample surface is characteristic of the atomic composition of the sample surface.

There follows a list of patents which relate to particle energy analysers.

U.S. Pat. No. 4,680,467-(1987), entitled ‘Electron spectroscopy system for chemical analysis of electrically isolated specimens’, discloses the use of a hemispherical analyser among other devices to aid XPS of insulators.

JP 119 9 140-(1989) entitled ‘Photoelectron spectroscopy for solid-state surface’ discloses the employment of an hemispherical analyser as one element in a device to measure excitation levels on a solid-state surface.

EP 059 0 308-(1994) entitled ‘Scanning and high-resolution x-ray photoelectron spectroscopy and imaging’ discloses employment of an hemispherical analyser and concentrates on primary monochromatic beam formation and signal detection.

EP 544 4 242-(1995) entitled ‘Scanning and high-resolution electron spectroscopy and imaging’ relates to creation of an XPS sample surface image using scanning techniques.

U.S. Pat. No. 6,326,617-(2001) entitled ‘Photoelectron spectroscopy apparatus’ discloses a device inside an XPS spectrometer using a combination of a photoelectron detector and electrodes, and electrostatic and magnetic lenses to disperse a photoelectron flux to increase the photoelectron-detection surface.

EP 117 0 778-(2002) entitled ‘Scanning and high-resolution electron spectroscopy and imaging’ discloses similar subject matter to the above referenced patent EP 544 4 242.

D. W. Turner, I. R. Plummer, H. Q. Porter in The Journal of Microscopy, 1984, 134, pp 259-277 disclose utilizing powerful electromagnetic field to determine electron trajectories.

EP 0 246 841 discloses employing an input objective lens, an input transfer lens, a toroidal capacitor, and output lens system and a detector.

U.S. Pat. No. 5,185,524 discloses an hemispherical reflector as an energy selecting imaging analyser for application in XPS.

The above referenced patents are relevant to the technical field but all have disadvantages which the present invention seeks to overcome.

In particular, in EP 544 4 242 a beam of primary particles is used to scan the subject surface, however this is time consuming.

In addition, in the method as described by D. W. Turner, I. R. Plummer, H. Q. Porter in Journal of Microscopy, 1984, 134, pp 259-277 powerful electromagnetic fields are utilised to determine electron trajectories and this necessitates costly electromagnets. This is inconsistent with the usual relatively low cost electrostatic field instruments used at present in surface analysis.

Imaging spectrometers using hemispherical or toroidal sectors have been reported by P. A. Coxon and I. M. R. Wardel in the above referenced patent EP 0 246 841, in which an input objective lens, an input transfer lens, a toroidal capacitor, an output lens system, and a detector are employed. The toroidal capacitor acts as an energy filter (analyser) and possess an input and output aperture which together with the radius curvatures and the strength of the toroidal field determine the analyser energy resolution. The transfer lens between the objective lens and the analyser images the objective lens cross over point (the point at the centre of the objective lens focus aperture) to the centre of the input aperture of the analyser.

The sample surface emission plane is imaged to the first focus point of the transfer lens. If the lens system had a perfect axial symmetry and no aberrations then a particle travelling to the analyser entry point would have the angle of inclination to the lens optical axis proportional to the coordinate of the emission point at the sample surface measured as a distance from the optical axis, i.e. all particles emitted from the same place at the sample would have parallel trajectories at the analyser input aperture.

The analyser electrostatic capacitor is employed with the first magnification of −1 and the angle of inclination is preserved at the output to the second order aberrations. The lens at the output of the analyser has its first focus point coinciding with the output aperture of the analyser and assuming no aberrations it would transfer a parallel electron beam into a point at a detector placed at the image focal plane.

In respect of aberrations of this system: a lens with magnification M, imaging a particle bundle with maximum inclination a, and energy spread e, has a spherical aberration Cs, proportional to M*(1+1/M)̂4*â3, and a chromatic aberration Cc, proportional to M*(1+1/M)̂2*e*a. From this it is apparent that that the combined aberration is at the combined minimum value for a value of M>1 and the combined value of aberration rapidly increases for M decreasing below <1. With all microscope modes M of the objective lens must be M>>1.

The combined aberration value outlined above becomes particularly significant for the system outlined in EP 0 246 841 as the lens before the analyser images the crossover point of the objective lens onto the analyser input slit and the objective image plane coincides with the focus plane of the transfer lens. Correspondingly, the distance from the first focal point of the transfer lens to the cross-over point of the objective lens is much greater than the diameter of the transfer lens and therefore the transfer lens operates with lens magnification M<<1.

Consequently the total image aberrations of the transfer lens are significant. The image parameters are given by a distance x, angle a from the optical axis, and a velocity v, such parameters being bound by the Liouville theorem for conservative fields x*a*v=const. A decrease in x would demand an increase in angle a, and therefore increase in the chromatic aberration Cc and the spherical aberration Cs. If the chromatic aberration Cc (where Cc is proportional to M*(1+1/M)̂2*e*a) is to be decreased, then e needs to decrease. For the analyser geometry at its optimum the only decrease in e comes from decrease in the velocity through the analyser. This, according to the Liouville theorem, increases the product x*a=const/v, so there is a limit in total magnification to which such a system of lenses can be applied.

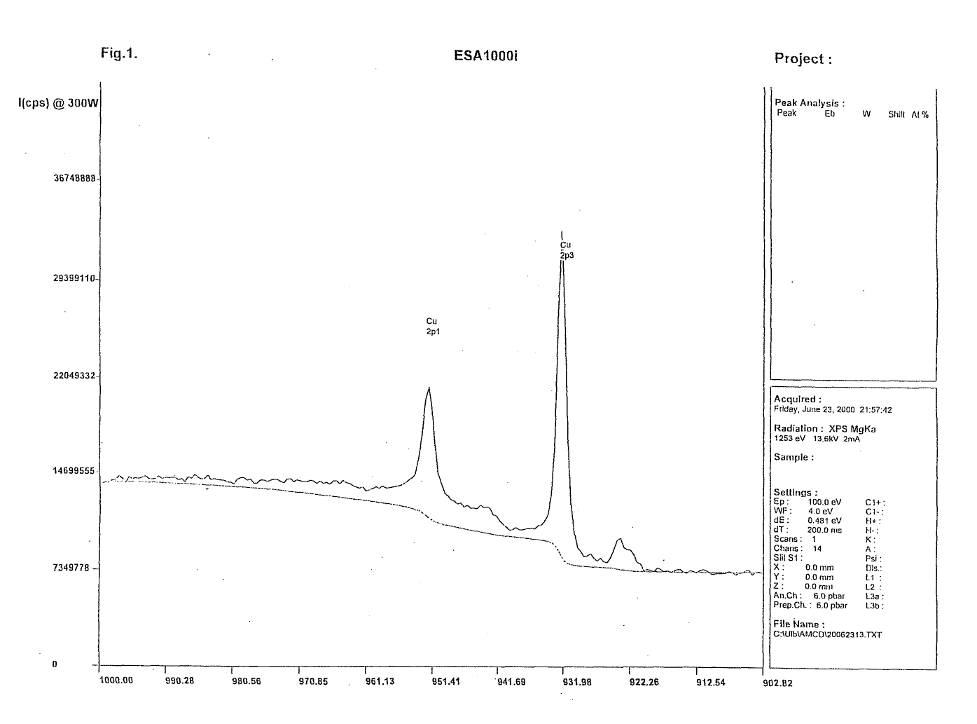

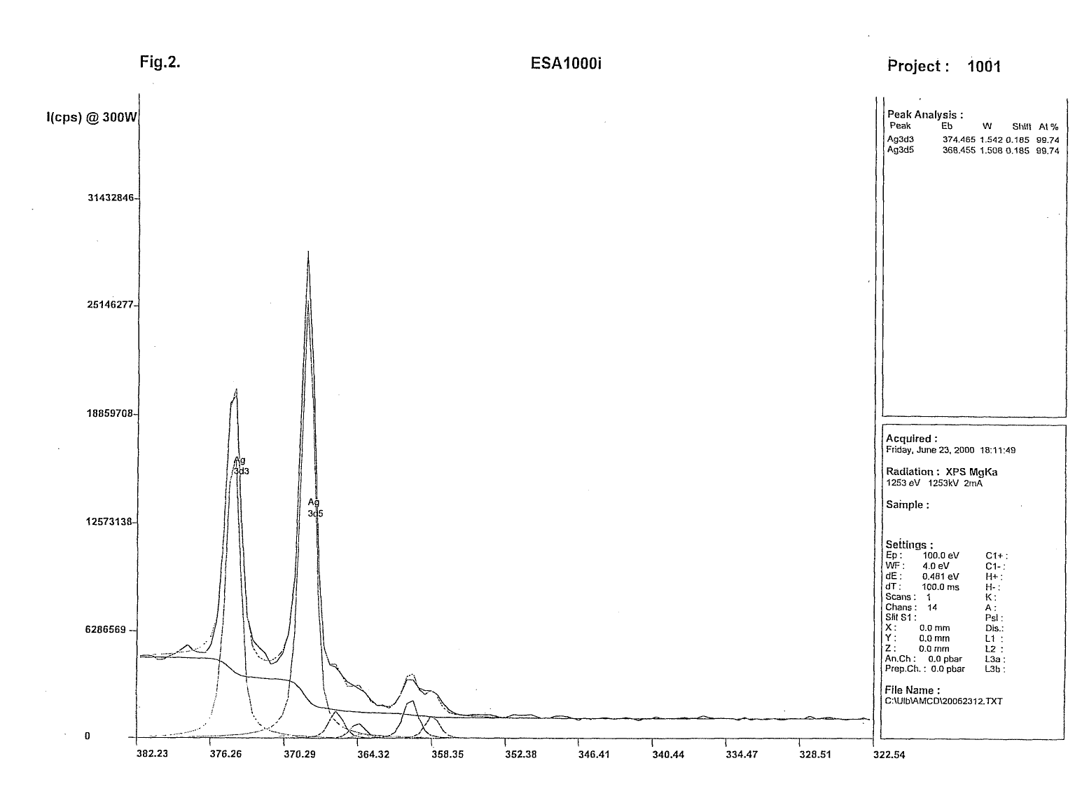

A further disadvantage is that only one image at one energy at a time can be collected, and this may not produce a meaningful data for the analysis, in particular as the XPS spectrum has substantial background, as can be seen from FIGS. 1 and 2. The correct analysis of the chemical composition at the sample surface should include the subtraction of the background from the total spectrum. Only the peak area should be included in the image analysis in order to calculate the chemical composition of the sample surface. This means that in addition to the spectrum, images have to be collected at different energies: at the peak energy of the spectrum, followed by energy corresponding to the background of the peak of the spectrum. Possibly images at several energies around the peak of the spectrum should be collected so that a correct routine for the signal-background subtraction for each peak energy of the spectrum is correctly employed.

A still further disadvantage is that the spectrometer has to operate at several different settings for lenses, analyser and detector, corresponding to its operation as a microscope and as a spectrometer, and from the operation of two sets of detectors, one for the spectra and one for the images. This again makes the quantitative analysis on images very difficult, as to how to accurately relate the data that generates the spectrum from the data that generates the image from the sample surface.

As set out above, U.S. Pat. No. 5,185,524 employs a hemispherical reflector as an energy selecting imaging analyser for application in XPS. The patent discloses a device consisting of a set of three concentric hemispheres. Two modes are employed, in a first mode it is employed as a conventional sector field analyser with a sector field angle of 180 degrees, with two inner hemispheres and a set of input and the output slits on the plane of a plate on which the three hemispheres are sitting. In a second(imaging) mode the two innermost electrodes and the plate are provided at the same potential to produce, with the outer hemisphere, a spherically symmetric reflecting field. The central hemisphere has a hollow region including a grid through which the electrons can go. A set of baffles are provided inside the reflecting field to restrict particles and produce a set of energy selecting slits. The reflecting spherical field combined with a field free region between the inner two electrodes achieve an imaging effect that is also energy selecting. However, it is optional to use this configuration for the ion mass spectrometry as well. Further disadvantages come from limitation to one image at a time and therefore the arguments are very similar to those of the EP 0 246 841 A2, Also use of an a-focal lens that limits the practical application to lower magnifications is necessary.

The task is therefore to devise a spectrometer which overcomes the problems and difficulties present in prior art devices. In particular a spectrometer with an analyser of a capacitor or electromagnetic type that is capable of producing an energy spectrum of particles emitted from a specified area on the sample and furthermore of producing an image of at least part of the sample using particles with an energy window selected by the same energy filter. Furthermore, this image should not be obtained by energy scanning. Furthermore, if possible this device should be combined as a mass spectrometer for secondary ions coming from the same sample area and for crystalline structures the same system should provide angular resolved spectroscopy for each of the selected areas on the sample surface. A combination of all these different techniques in one instrument, with one sampling area with well defined instrument transmission for each aspect of the quantitative analysis of micro and nano-structures is the task set out in this patent application.

### THE PRESENT INVENTION

It is an object of the present invention to provide a particle energy spectrometer having an analyser of a sector field type that is capable of providing an energy spectrum, angle resolved energy spectrum and mass spectrum of particles emitted from a small area of a sample and of imaging a part of the sample surface using particles with a selected range of energy or mass and all these different examination techniques having the same analyser the same detector and the same field of view.
1. In accordance with a first aspect of the present invention, there is provided a particle spectrometer operable to produce an image of a particle emitting surface, said spectrometer comprising
a) means of particles to be emitted from said surface particles being transmitted through said surface thereafter referred as a sample surface
b) means of restricting particles according to predetermined criteria in this aspect of invention restricting particles according to certain directions of travel from said surface; the criterion being certain range of angles to the axis perpendicular to said surface
c) a first particle lens arranged to project an image at least some of particles onto a lens image plane and having an angle restricting aperture near the focus plane
d) an electromagnetic imaging analyser with at least two pairs of object and image planes the first object plane coincides with an image (we say being conjugate) of said sample plane; this object plane is imaged by said analyser onto a first image plane of the analyser that coincides or is conjugate with the plane of a particle detector; the second pair of said object and image planes are arranged to project particles and disperse them according to their energy.
e) energy selection means for transmitting particles entering said second object plane having energies only within a selected range
f) energy selection means at the second objective plane of the analyser input is arranged to coincide or is conjugate with the focus plane of the first particle lens.

Preferably,

a)Between the first particle lens and the imaging analyser there is placed another electromagnetic lens which receives an image of the first lens and projects it onto the first object plane of the analyser.

b)Also preferably the magnification of the first and the second lenses are variable to adjust for optimum magnification. Also on the image plane of the first particle lens there is an aperture for selection of a sample area viewed by the analyser.

c) in a further preferred embodiment the method comprises means of changing the particle kinetic energy before they enter the electromagnetic field of said imaging analyser so that their desired energy resolution is obtained following energy dispersion in the electromagnetic field.
2. In accordance with a second aspect of the present invention, there is provided means of arranging said analyser as a time of flight mass spectrometer. For this apply all points of the first aspect of the invention, in addition to them there is provided
   a) a detector with means of selecting or determining a time interval at which incoming particles are recorded,
   b) a means of controlling time interval with which primary particles (form excitation sources) hit the sample surface
   c) a means of registering the flight time of ions arriving at the detector

Preferably a lens system placed between the first analyser image plane and the detector, that images the first image plane onto the detector; the lens preferably having a variable magnification and particle acceleration to accommodate differences in the desired electrode potentials at the exit from the analyser field and the detector surface.

In this way the flight times through the lens systems can be varied with respect to the particle flight time through the analyser so that effects of particle energy dispersion inside the analyser is compensated for by suitable selection of flight times. This effect is well covered in the literature and such means of compensating for energy dispersion and its effect on the total flight time (time of flight between the sample surface and the detector) of particles. The additional benefit of the present invention is that the detector receives images of the sample surface at a set of predefined energies.

Further features and advantages of the present invention will be apparent from the following detailed description of preferred embodiments of the present invention, with reference to the accompanying drawings, in which:

FIG. 1 Illustrates an X-Ray photoelectron spectrum, shows a schematic diagram of an XPS spectrum with depicted background from the inelastic scattering,

FIG. 2 Shows peak fitting on Ag3d5 Ag3d3 doublet structure, a schematic diagram of an XPS spectrum with the background subtraction carried out,

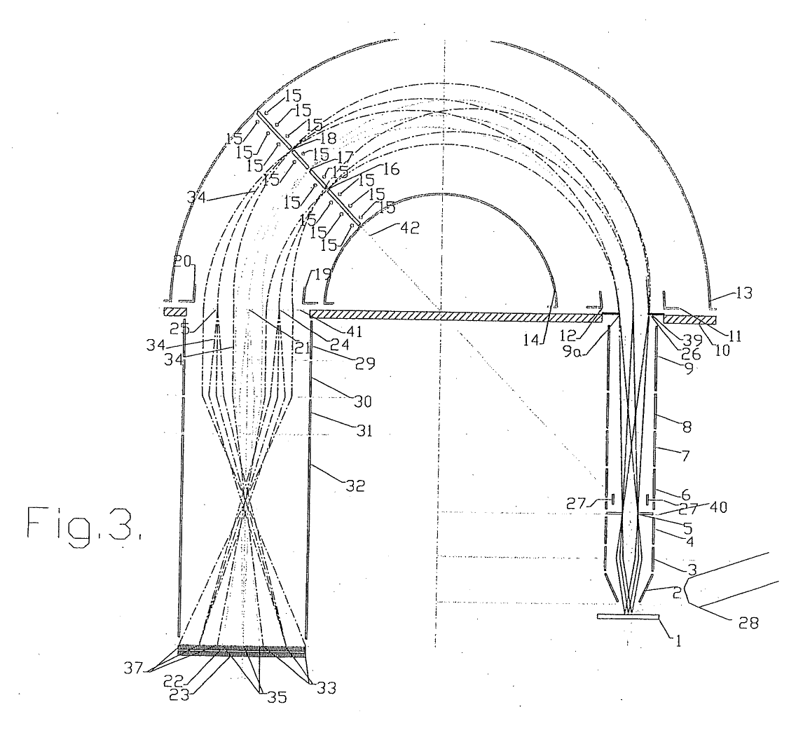

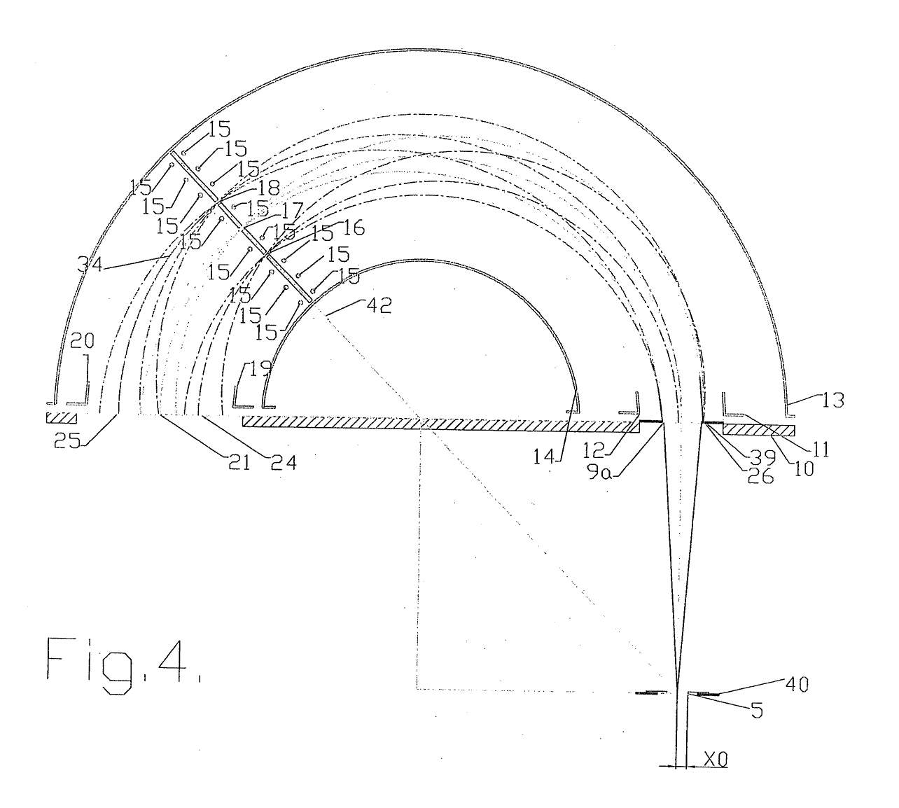

FIG. 3 shows a construction of a combined particle spectrometer and microscope in accordance with one embodiment of the present invention and shows a schematic diagram of the spectrometer-microscope's analyser.

FIG. 4 shows a further schematic diagram of the spectrometer-microscope's analyser,

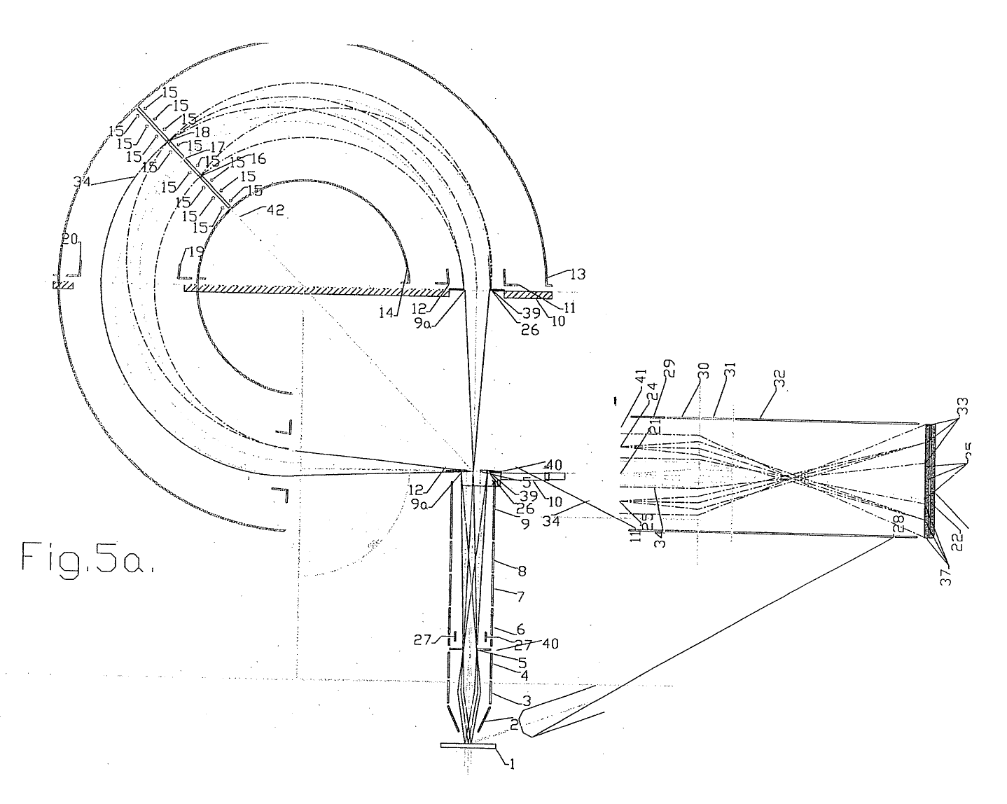

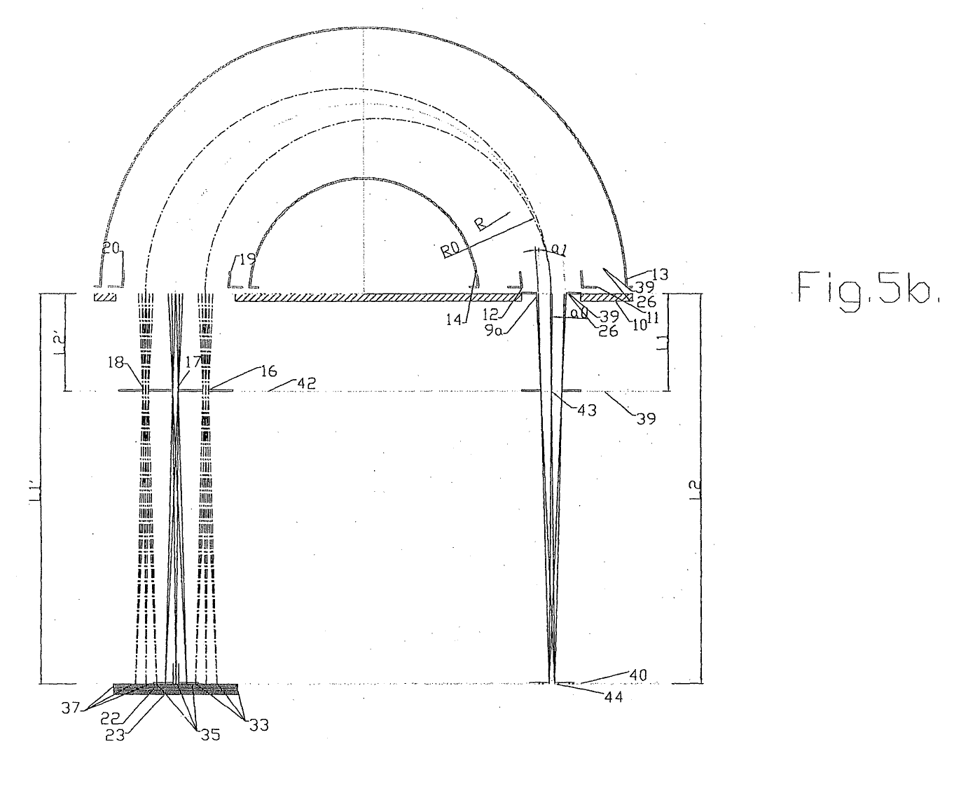

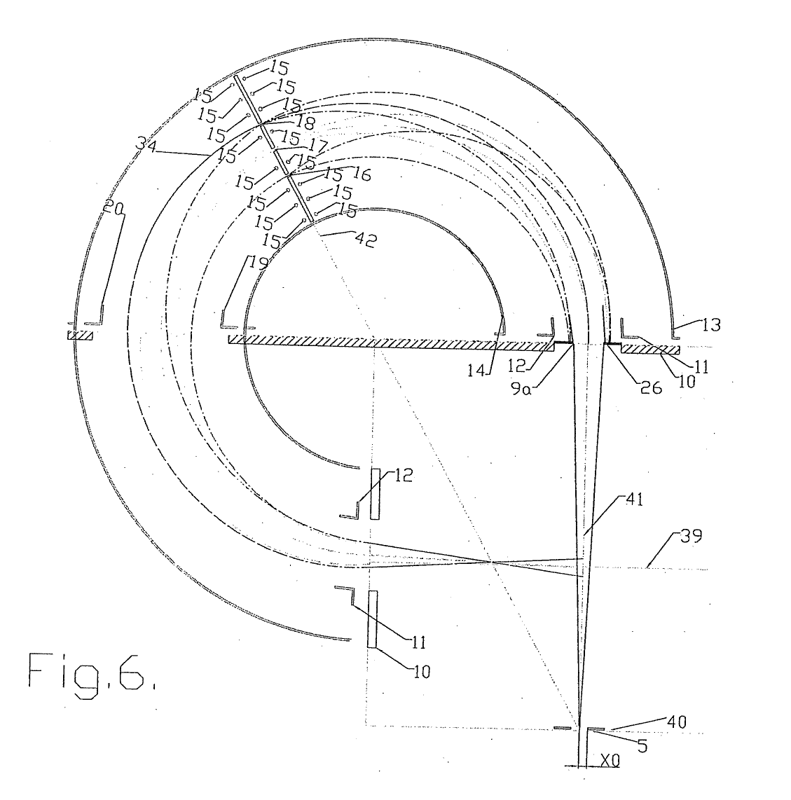

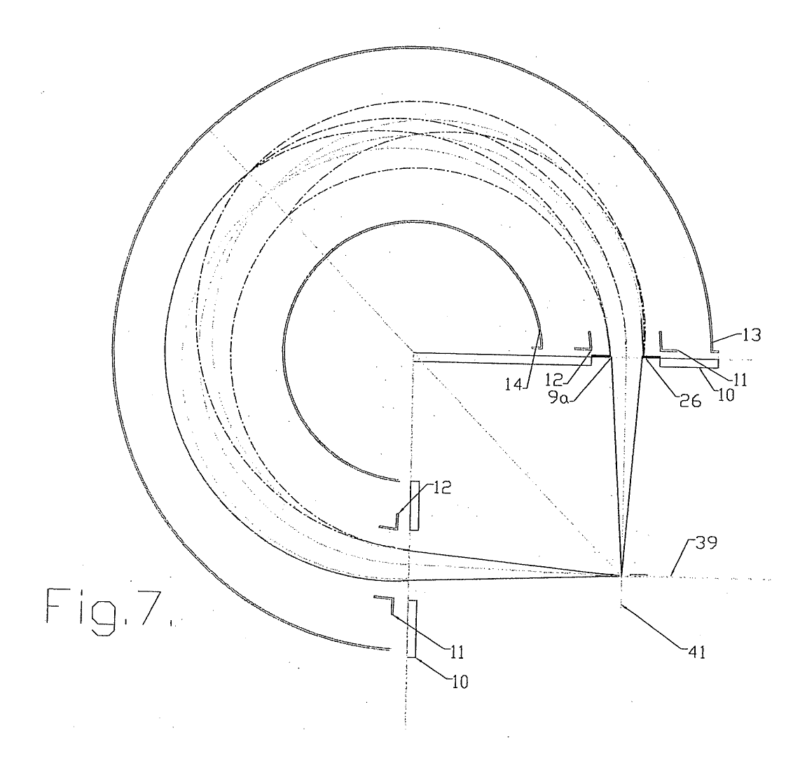

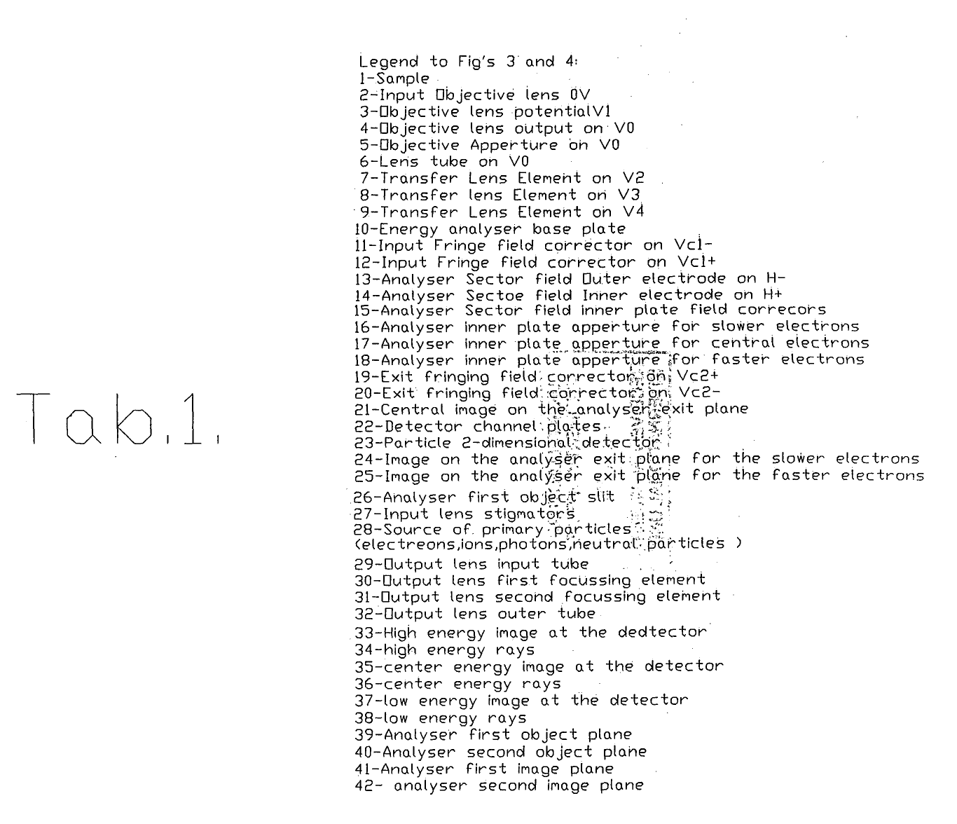

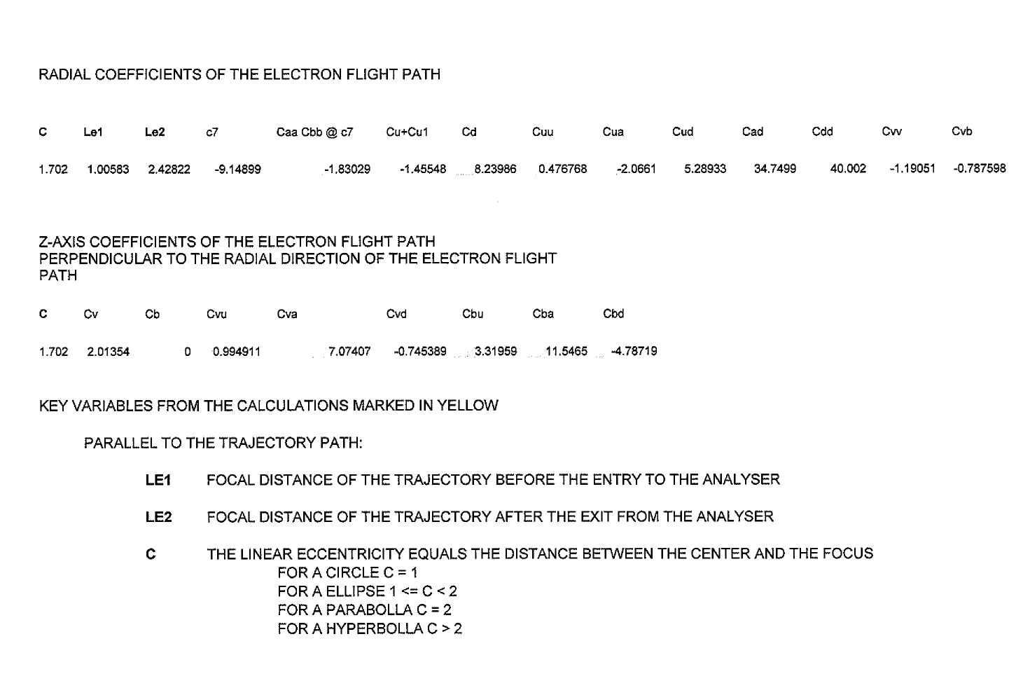

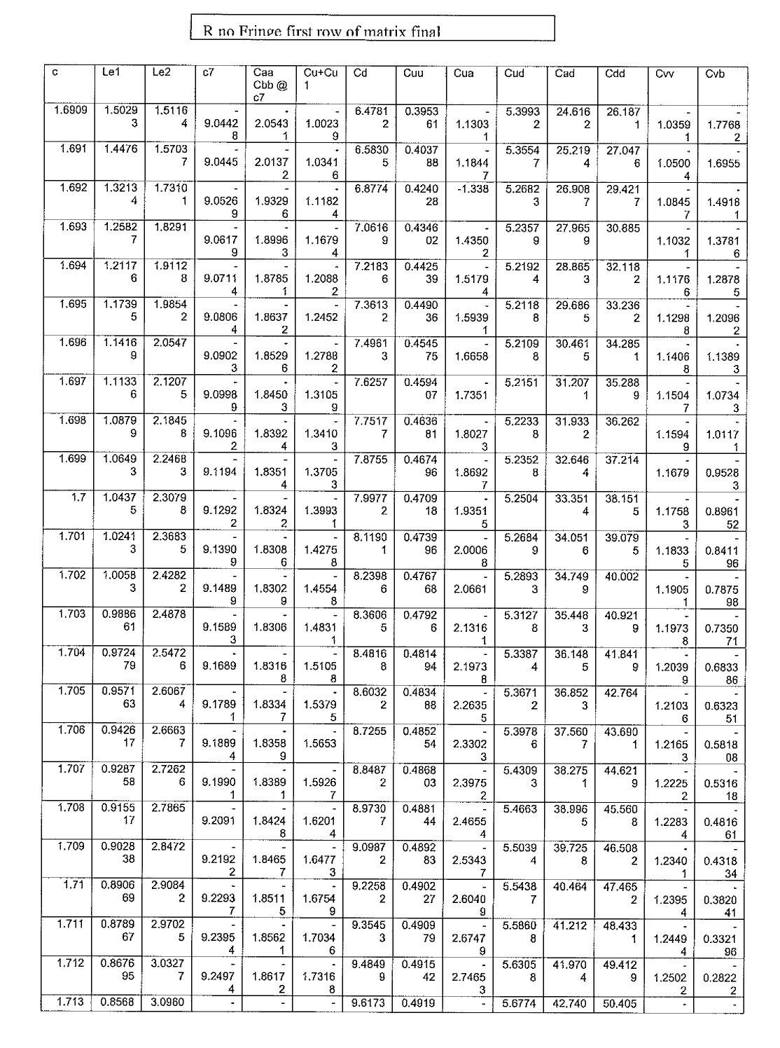

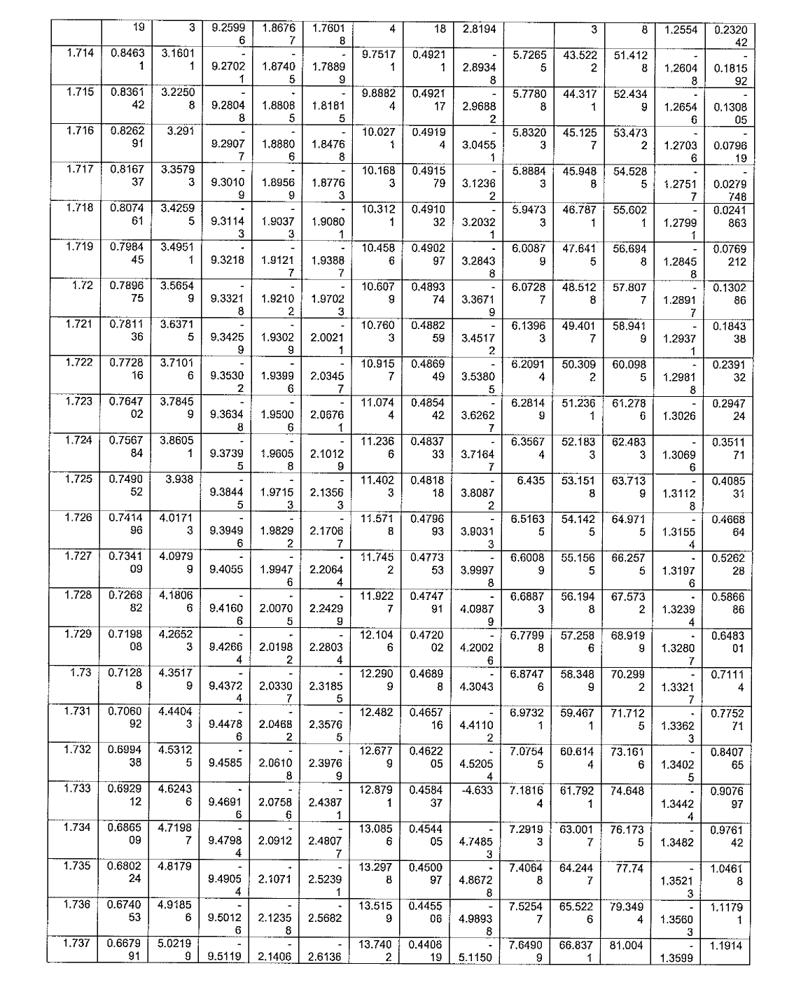

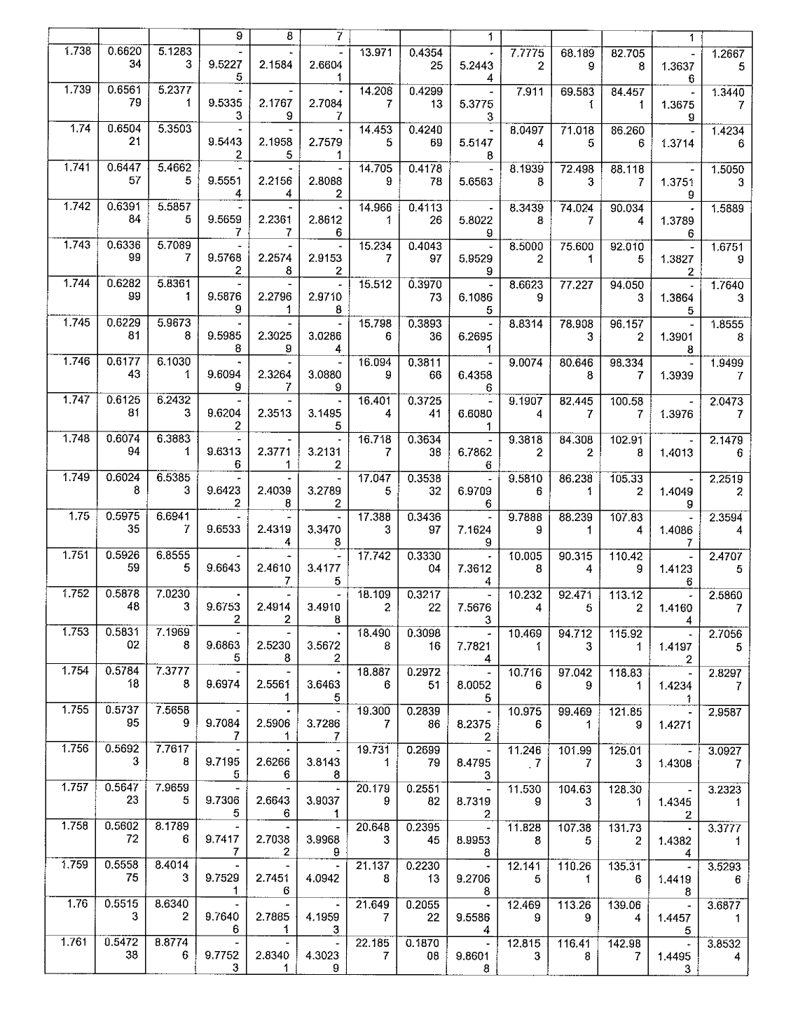

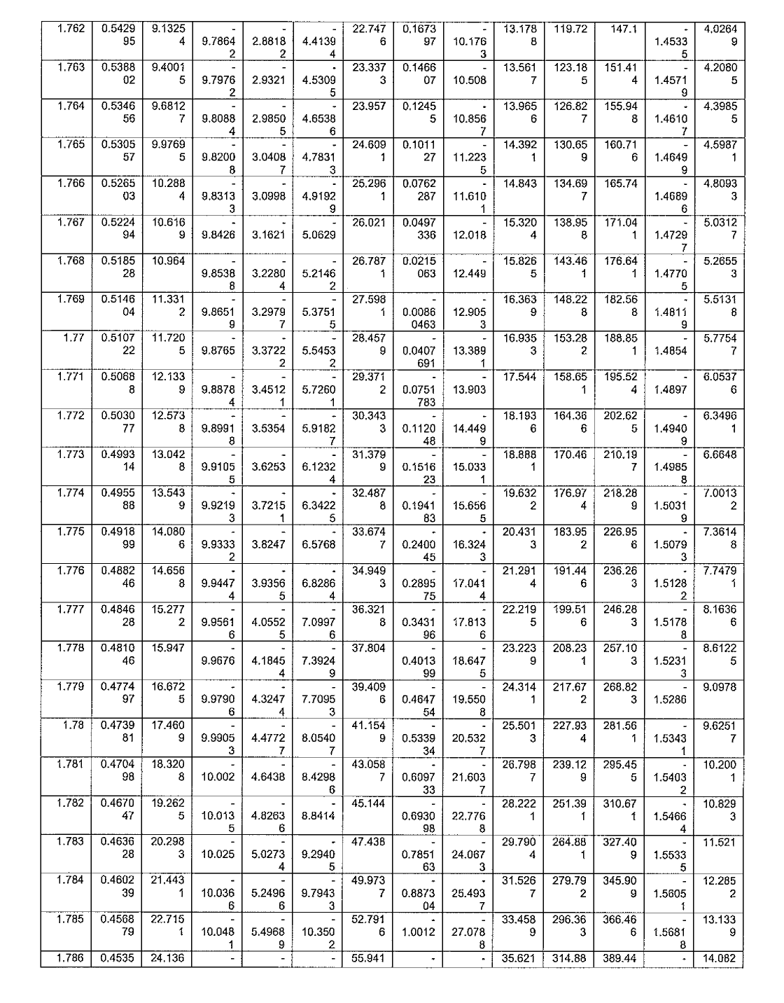

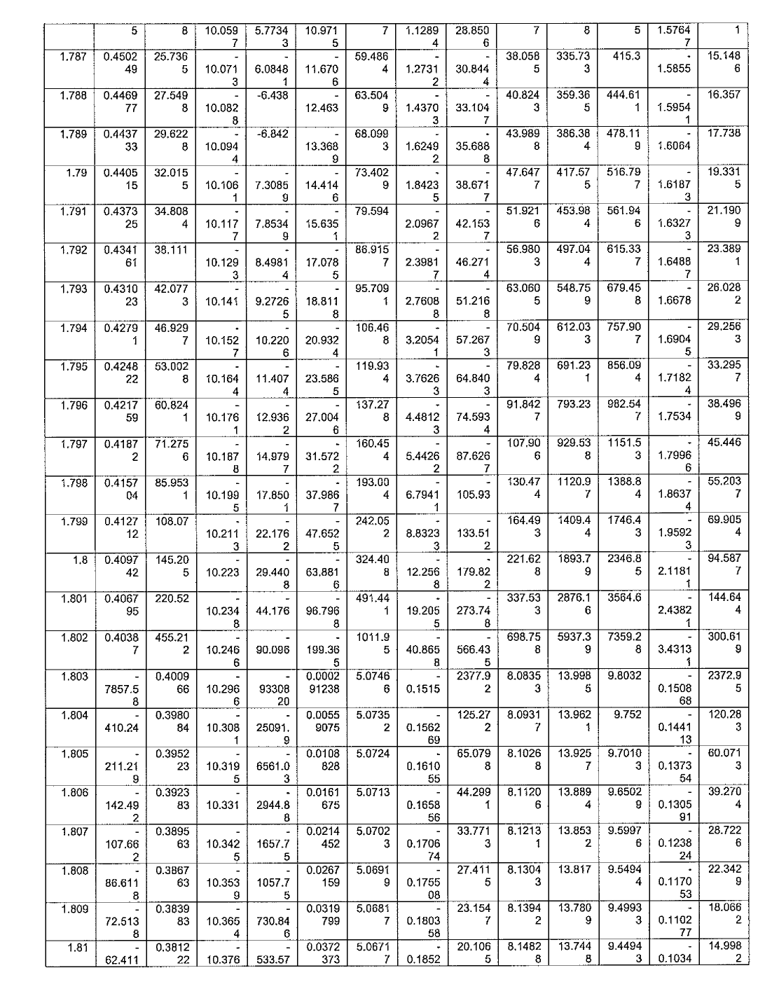

FIG. 5a shows a construction of the spectrometer where the sector field of the analyzer is of a toroidal or spheroidal type, in accordance with a third embodiment of the present invention,

FIG. 5b shows a further view of the spectrometer of FIG. 5a,

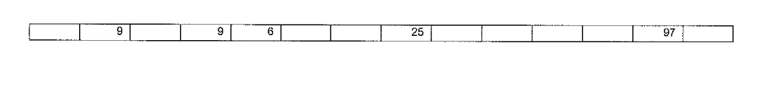

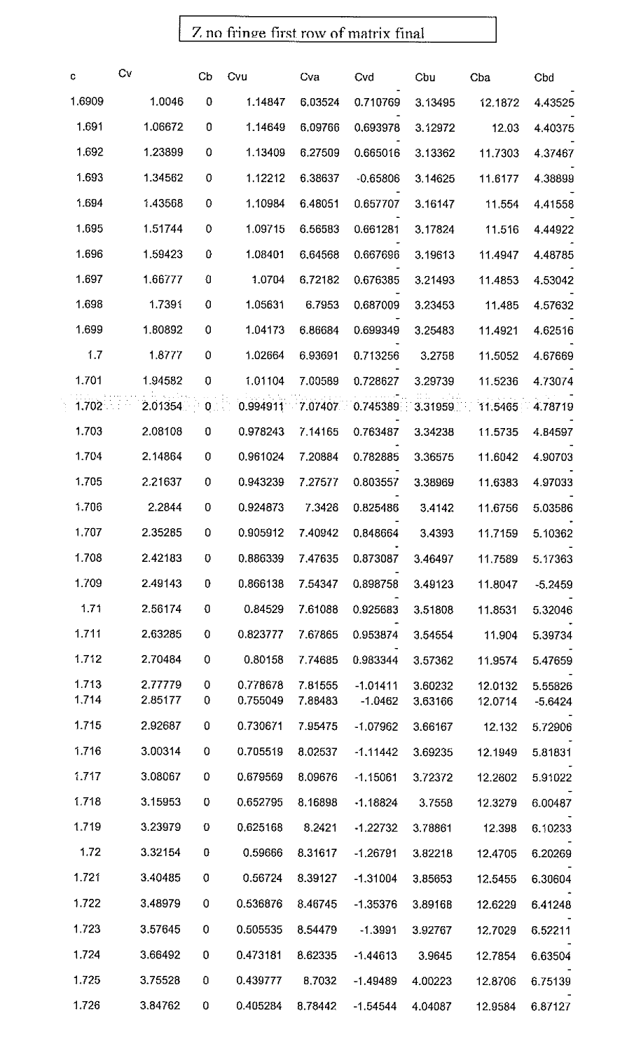

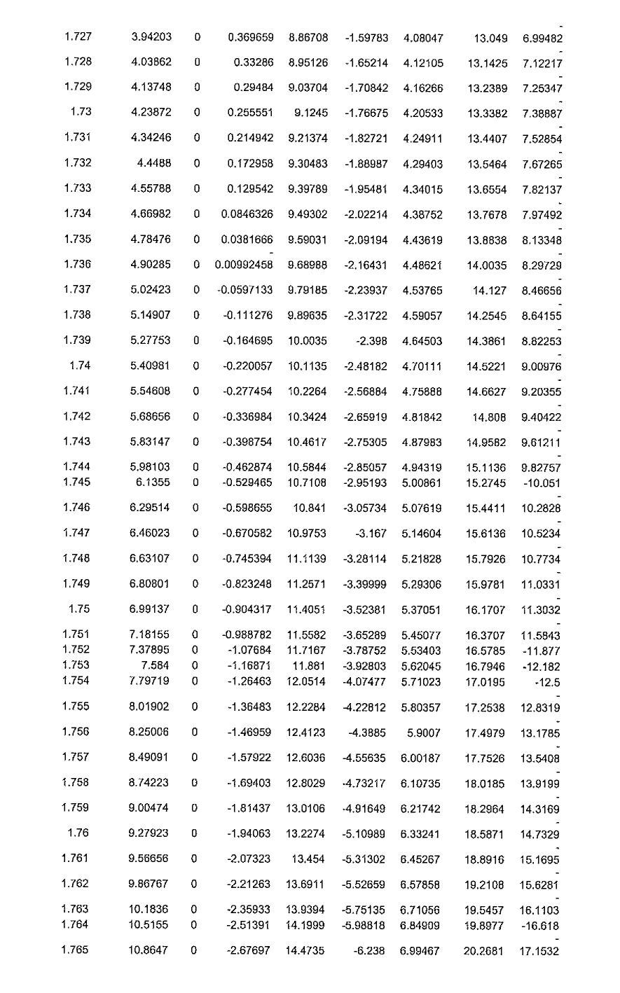

FIG. 6 shows an example of the combination of the two sector fields in tandem, and shows the beam energy selection, and

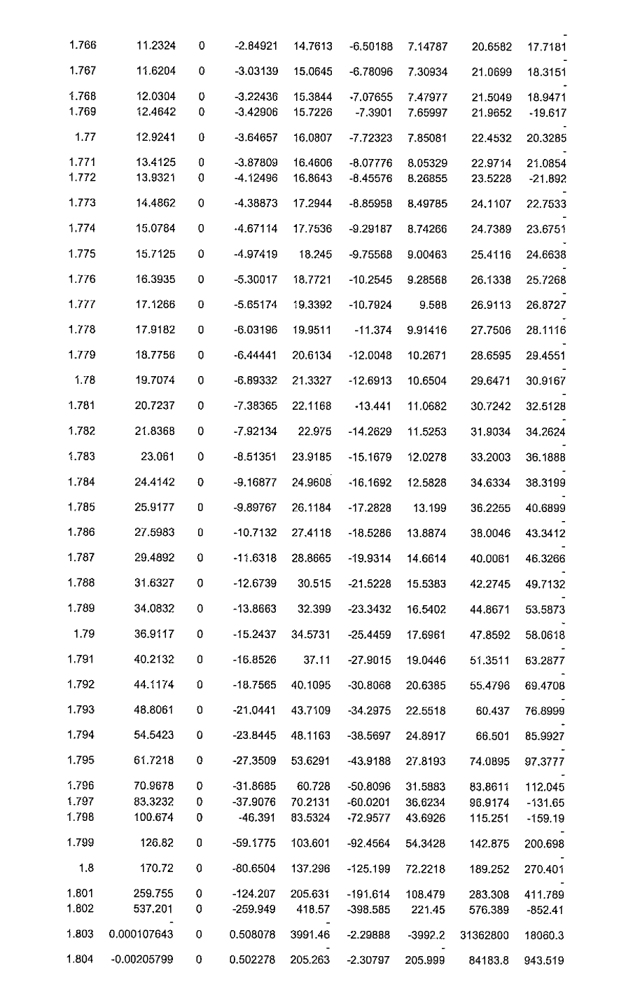

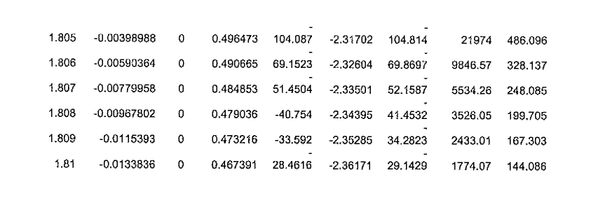

FIG. 7 relates to the same spectrometer as in FIG. 6 but shows imaging for the microscopy.

FIG. 1 shows an X-ray photoelectron spectrum which consists of number of peaks corresponding to resonance levels of x-ray photoelectron emission. As can be seen, each of the peaks (e.g. Cu 2p3 at 932.67 eV and Cu 2p1 at 952.49 eV binding energies) is accompanied by a background structure. The higher binding energy side of the peak corresponds to inelastic scattering of photoelectrons ejected from the sample, see e.g. Briggs & Seah, Practical Surface analysis. This results in the general increase in the background level on the higher binding energy side combined with some possible plasmon structure as is seen some 12 eV behind the main peak (at 943. eV for the Cu2p3 and 965 eV for Cu2p1).

FIG. 2 shows in detail this process of peak fitting on Ag3d5 Ag3d3 doublet structure. There is seen the background, in the Shirley model, rising towards higher binding energies by amount proportional to the peak area;
The small plasmon peak at some 4 eV higher binding energies
Two X-ray satellite structures 4.5 eV, 9.4 eV and 10.15 eV bellow the main peak energy.

In order to obtain meaningful information provided by the photo-emission process at one feature, e.g. Cu2p3, an image has to be created at the peak for the binding energy Be(Peak)=932.67, followed by a number of images next to the peak energy in order to accurately subtract the peak background and if possible eliminate contributions from all other features such as those coming from X-ray satellites, plasmon losses, etc. This requires mathematical manipulation of these images at various energies round that main peak, so that the true contribution of the background at the peak energy over the whole image area can be assessed and subtracted from the image at the main peak energy to obtain a true contribution from the Cu2p3 line itself.

This process is time consuming in real time, especially for small intensities. For instance C1s features 300 W, MgKa in a polymer collection of images can take several minutes to an hour. For a five micron spatial resolution, the image collection can take over an hour for each of the images. It would therefore be helpful to be able to collect these images at various energies in parallel if possible.

A first embodiment of the combined particle spectrometer and microscope will now be described with reference to FIGS. 3 and 4. In addition, reference will be made to Table 1 which shows the Legend to the FIG. 3 and FIG. 4.

As can be seen from FIG. 3, a source (28) of primary particles (electrons, ions, neutrals, subatomic particles) illuminates a sample provided on plate 1 resulting in the production of secondary charged particles (electrons, ions, etc.)

These secondary charged, or emitted, particles are received through the objective lens represented here by elements (2), (3), (4). At or near the focal plane (40), at so called cross-over point of the particle beam there is shown an objective aperture (5). This aperture selects particles by their maximum take-off angle (between the emission direction and the optical axis running through the centre of the lens and the aperture (5)). This aperture is preferably adjustable to select the appropriate compromise between the imaging aberrations and image brightness.

The stigmatic aberrations of the objective lens are corrected by a set of stigmators (27.) In this illustration the objective lens is shown to produce an image at the aperture plate 9a. This aperture is preferably adjustable to select area on the sample for analysis. Although not shown in FIG. 3 the image of the sample surface at (9a) can be made in front of a transfer lens represented here by elements (6), (7), (8), (9) and imaged onto the aperture (39) at the entry to the analyser. The object of this lens is to enable the lens system to adjust magnifications to their optimum relations to the size of the sample and to set the of particles energy (pass energy E0) of particles passing through the analyser. This is related to the system energy resolution. There is a possibility to use a multiple of transfer lenses for choice of magnifications and each of them will have a cross-over point and an object and image plane. Each object and image planes of those lenses coincide or are (conjugate) images of the sample surface and each cross-over point is an image (conjugate) of the cross-over point of the objective lens.

The analyser as an imaging device has two pairs of object and image planes. Particles emitted from one point of the (object) plane are selected by the range of energies or masses and transmitted through the analyser and imaged onto the point of the conjugate plane.

The object plane of the first pair is conjugate to the image planes of the input lenses and therefore to the sample surface.

The object plane of the second pair is preferably conjugate to the cross-over point of the input lenses. In FIG. 3. it coincides with the centre of the aperture (5)

The image of the sample surface (1) is show in FIG. 3. to be conjugate to the first object plane (shown to coincide with plate 10) of the analyser at the beginning of the sector field (39), which itself is conjugate to the output exit plane (21),(24),(25) of the analyser where the final image can be detected.

The centre of the aperture (5), is shown here to image (conjugate) to the aperture (17), the Analyser Timer Plate aperture for the electron beams.

The analyser contains a number of slits (16),(17),(18) inside the sector field coinciding with the second image plane. A combination of (17) and one of the slits 16,17,18 selects particles by the desired range of energies

The analyser sector field is produced by a pair of electrodes provided by the housing of the spectrometer, an outer electrode H−(13), and an inner electrode H+(14), an analyser plate (10) and a set of fringe field correctors at the sector field input (11),(12) and the sector field output (19),(20).

Operation of the imaging spectrometer in this embodiment can be considered in three cases

Case 1: Analyser imaging the sample surface at selected particle energies

The energy selection takes place between the aperture on the second object plane (which in FIG. 3. coincides with the aperture (5)) and the one of the apertures (16),(17),(18) in the second image plane. Energy selected imaging takes place between aperture on the first object plane (26) (in FIG. 3. coinciding with the aperture (9a)) and the first imaging plane (41). In FIG. 3. the images with the centres at (24),(21), and (25) relate to different range of energies as selected by the slits (16),(17),(18) respectively.

With a projector lens represented in the FIG. 3. by the elements (29),(30),(31),(32) these are further imaged onto different parts (37),(35),(33) of the detector (22) respectively.

Case 2 Analyser imaging the distribution of particles according to the angle of take-off from the sample surface at selected particle energies

For the analyser acting as an imaging device for the angular distribution of the particles with the selected energy range the sample is illuminated at an area small enough to be considered as a point. Then the distribution of particles coming through the different points on the surface of the aperture (5) correspond to the particles with the different take-off angle at the sample. The spectrometer is arranged in such a way that the first image plane of the analyser would be conjugate with the input lens cross-over points and the second object plane would be coincident with the image of the sample surface. The pair of the slits on the second analyser planes would still be responsible for the energy selection and the first pair of slits image the distribution of particles on the angle selecting aperture and therefore obtain the image of the particle distribution according to their take off angle. The same arrangement of the slits 16,17,18 as in the case 1 would enable to collect plurality of images at the detector 22 much the same way as in the case 1.

Case 3.

For the analyser to act as an imaging time of flight mass spectrometer The mass of the particle is selected according to their flight time between the sample and the detector. The object of the spectrometer is to compensate for the different energies of the particles that have the same mass. In the space of the analyser sector field the particle with the higher kinetic energy would have the trajectory with the greater radius and therefore spend longer time in the field than the particle with lower energy. On the other hand outside the sector field where lenses are, the most of the space there is field free. So the high particles that have higher velocities drift through this space quicker than the low energy ones. So the right combination of the two spaces can compensate the conflicting effects so that the flight times are independent to the second order of the derivative with the energy.

The present invention takes this further as at the same time as the compensation of energy the analyser as depected in FIG. 3. can also image sample surface at the detector (22). If the detector (22) records at the specific time after the pulse of secondary ions is produced at the sample 1 the places detected at the detector (22) and centred round the points (33),(35),(37) detect the images with particles of different energies but for the same time arrival they would detect particles with the same mass. Over and above the normal time of flight spectrum it would distinguish anomalies that arrive from the species that have multiple ionic charge and therefore obscure the usual energy compensation which assumes one electron charge per particle. The particles with double charge undergo electrostatic force double that of the single charge. This is significant especially for the trajectories through the analyser and therefore exit from the sector field faster than that expected from the energy compensation.

FIG. 4 shows a schematic diagram of the imaging analyser. The analyser is shown to operate simultaneously in two modes with the two sets of object and image planes.

The first object plane is an image of the sample surface and is at the aperture (9a). The second image plane is at the location (40) and is here represented by the aperture half width X0. This acts as an input aperture for the energy selection When the analyser operates as an energy filter the image plane which coincides with the first object plane contains an energy-filtered image of the sample.

Taking an example of an electrostatic hemispherical analyser, its imaging properties between the first object and image planes is given by the aberration disc produced at the image plane. We take into account that imaging between the first analyser planes takes place over 180 degrees of the focusing field,

d2=d1+R0*(Ce*e+Caa′*a1̂2+Cee′*ê2)+third order aberration terms (1)

Where:
d2 is the half size of the aberration disc at the analyser first image plane
R0 is the radius of central trajectory going through the centre of (9a) and 17 (see FIG. 4.),
d1 is the half size of the aberration disc at the analyser first object plane the radius R0 of central trajectory(see FIG. 4.),
e is the energy spread, normalized to the the analyser pass energy E0 of a particle ascribing a circular trajectory at the center of the bundle and having a radius R0, and coming to the slit (17)
a1 is the angle between the direction of the normal to the face plate 10 and the direction at which the particle travelling through the analyser approach the face 39 at the field entry.
Ce, Caa, Cee are the aberration coefficients which, for the purpose of calculating the aberration disc are, we en in the absolute value
Ce=2 is the energy dispersion coefficient for the analyser with 180 deg sector
Caa=2 is the absolute value of spherical aberration
Cee=2 is the second order coef for the energy spread

Taking into account that the particle travels in a straight line given by the distance L2 between the centre of the angle restricting aperture (5) and the first object plane, a1 is given by:

a1=x0/L2 (2)

where: X0 is the half size of the angle restricting aperture, and
L2 is the distance between the analyser objective planes

The energy spread e is determined by the part of the analyser operating between the second object plane running through the centre of the aperture 5 and the second image plane adjacent apertures 16, 17, 18, The analyser focusing field for the energy selection is made between the electrodes 13,14 the plate 10 and the field correctors 11,12 in the vicinity of the particle entry into the field and the correctors 15 in the vicinity of the second image plane and the output energy selecting slits 16,17,18. In the case of the hemispherical sector as described above in relation to FIG. 3 the second image plane is now inside the focusing field, so that only a part of that focusing field is now used for the energy selection. As shown in the FIG. 3. this is some 135 degrees the centre of the second object aperture the centre of the hemispheres and the second image plane apertures being in lineAS it is shown in FIG. 4. a particle emitted in the centre of the aperture X0 is imaged to a point on the line extending from this point through the centre of hemispheres to the line indicated by apertures 16,17.18 And any point on this line in the vicinity of X0 is imaged on the same line defined by 16,17,18. So the second object plane of the analyser which is used for the energy selection is tilted by an angle theta

The half size X0 of the aperture at the second object plane as shown in FIG. 4, is related to the size of the input aperture for the energy filter, As the second object plane goes through the centre of that aperture. The size of the input aperture for the energy filter S1 is given by

S1=X0/Cos [theta] (2a)

Where theta is the angle between the plane of the aperture X0 (FIG. 4.) and the line connecting the centre of the aperture X0 with the centre of the analyser. The size (S2) of the image aperture at the second image plane gives the image aperture for the energy filter. For this the sector angle of the focusing field 135 degrees

s2=s1/Sqrt(2) (2b)

The energy resolution of the energy filter is given by to the second order of imaging aberrations is given by:

e=Ep/2*[(S1+S2)/R0+a0̂2*Daa+a0*S1/R0*Dxa+(S1/R0)̂2*Dxx] (3)

Where:
a0 is the acceptance angle of the energy filter.
Ep is the pass energy
R0 is the radius of the central trajectory

The quantity a0 is given by the half diameter of the sample area as imaged at the analyser first object plane divided by the distance L2 between the first object plane and the aperture centre at X0. M is the input lens magnification.

a0=M*X00/L2 (4)

where: e is the energy spread normalized to the E0 as above, and
the aberration coefficients for the energy selection are:

Daa=2.3 (5a)

Dxa=−2 (5b)

Dxx=1 (5c)

Suggested construction parameters for the device are shown below.

The spectrometer objective lens is imaging the sample surface onto the entry of sector field, i.e. at the first object plane. Such lenses have been constructed and are well known. For instance it can consist of a 3-stage electrostatic lens system with the first stage as an objective lens with a focusing aperture x0<=0.1 mm focus length 20 mm followed by the same construction 200 mm apart in order to achieve the resolution of 20 nm and analysis area 20 um×20 um.

The choice of parameters of the energy analyser is not a contributory factor to the spatial resolution of the microscope.

The biggest contribution to the aberration disc at the exit plane, d2 is from the first order terms S1+S2 and the spherical aberration term R0*a0̂2*Daa.

S0=0.06 mm; radius of the objective aperture

X00=0.005 mm; half size of the sampling area on the sample surface in the dispersive direction

L1=100 mm; distance between the first and second objective planes of the analyser

R0=100 mm; Mean radius of the electrostatic sector analyser

M=210; Magnification of the input lens before the analyser

g=45 degrees;

a00=5.0 e−2 rad;

D=2

The relative energy spread for the analyser e=8.200 E−06 per channel.

Even for the operation in which energy selected images are produced at the detector we distinguish between different cases depending whether or not the sample is kept in the field free region or whether the sample is in the electric field.

Case 1
1.) In the XPEEM mode sample surface is biased to high voltage so that particles emitted from the sample are directly accelerated from the sample into the lens system. At the exit of the first lens the particle has the same kinetic energy with which it passes through the imaging analyser (pass energy E0). By immediate acceleration at the sample the particles become almost parallel to the optical axis and that reduces imaging aberrations in the whole system and give a better spatial resolution. The down side is the energy window increases with E0 for a given analyser so this has limited applicability for chemical analysis where measurements of chemical shifts in binding energies require adequate energy resolutions.
2.) The above technique is therefore needed in combination with a standard XPS spectrometer and uXPS microscope modes where the sample is kept outside the electrostatic field and where the preference has to be given to high energy resolution alongside with an adequate spatial resolution for the microscopy..
3.) There is also SIMS mode where the particles are ions and these are accelerated into the first lens as in the XPEEM mode but the imaging analyser functions in conjunction with the lens system as a mass selector. This technique should be understood as a complementary method to those two above as it gives information molecular weight of the species coming from the surface and unlike the other two it is not limited to the molecular size. But unlike those in 1.) and 2.), this technique is destructive as it removes atoms, ions and clusters from the surface, so a combination of all three through one analyser and one field of view and analysis area gives that what is required for the quantitative analysis of micro- and nano-structures.

In the following we turn to the mode 1.)-XPEEM.

If any analyzed particles are accelerated from Ek=100 eV to Ep=35 kV before entering the electrostatic sector with a lens magnification M=240, then according to the Louville theorem the input angle a1 into the electrostatic sector is given by:

a1=a00/M*(Ek/Ep)̂½ (7)

The focusing aperture is imaged accordingly de-magnified. If L1 is the drift length (as a distance between the two object planes before the analyser the size of the objective aperture image is given by:

S1=a1*L1 (8)

And the input focus aperture de-magnifies from S0 into S1==1.7 E−4
S1=0.00017 mm, and
a1=1.0 E−6,
a0=MX00/(2*L1)=240*0.00125/200=1.4.0 E−3
In the brackets of Eq.(6)
Term1=1 um
Term2=2/D*Daa *R0*a0̂2=2.3*100*(2 E−6)=0.46. um
Term3=2/D*a0*S1*Dxa=0.0014*0.00017*2=0.0004 um
Term4=(S1̂2/R0)*Dxx=(0.0005)̂2/150*1<0.005 um
Term5=R0*2*(S1/L1)̂2=150*2*(0.00001)̂2<0.00003 um

Term2, the spherical aberration term, is the most significant and is dependent on the square of the size of the image at the analyser entry plane in the dispersion direction divided by the object length L1.

If the analyser is operated in the XPEEM mode, the particles are accelerated to 25000 eV giving the energy window of 1 eV per channel.

So far we have dealt with the image aberrations for the trajectories in the radial direction (i.e. perpendicular to the spherical equipotential surfaces at which energy dispersion occurs). In the axial direction (i.e. along the tangent of the spherical equipotential surfaces of the hemispherical field) the analyser images exactly, with no aberrations to the second order. Therefore it is possible to take an image in the non-dispersive direction along the Y-axis. This image can be as large as aberrations of the objective lens allow. Therefore we can take an image of 250 pixels in the dispersion direction and 1000 pixels in the non-dispersive direction.

With 250×1000 pixel samples it is possible to achieve resolutions between 10 and 20 nm for each of several images in a row with different sampling energies. This is especially useful when spectra taken from the same sampling area are required, in which case we have not only multi-channel detection in spectrum points, but also in imaged information.

In order to decrease the spherical aberrations of the analyser system it is possible to place an accelerating lens just before the first image plane.

As an example of use within an XPS application the spectrometer transmission is calculated as follows: an 0.1 mm objective aperture accepts the input angle a00=0.02 rad and solid angle π*(0.02)̂2 srad. A laboratory X-ray source with an emission flux from the sample, for example Ag 3d 5/2 line can achieve:

I0=5×10̂10 cps/eV/srad/mm̂2

The intensity I per pixel of size p*dr̂2 (dr=pixel radius) is calculated from:

I=I0*dE*π*a00̂2*π*dr̂2 (9)

In true XPEEM mode the particles at an initial energy of 10 eV are accelerated to 25 keV at the sample towards the first lens stage. In the XPS microscope mode the sample is accelerated through the lens system.

Using the values set out in Table 2 with equation 9 we find:

I=8.90 E−02 cps per pixel

Thus, in the present sample, a legible image is produced with 30 cts per pixel in a time of 337 seconds. This is an example only of that which may be achieved by the present invention, it is contemplated that other values and savings will be apparent to the skilled man, and the present invention is not limited to such values.

If 30 images are collected simultaneously at the analyser output, the above number is reduced to T30i1 (30 chan)=11.2 seconds. Thus, in laboratory conditions and without the need for expensive high intensity synchrotron radiation source the instrument that is the subject of the present invention could produce a survey spectrum of 300 points with 30 cts/pixel for each pixel of the sampling area in T30i300(30 chans)<1 hour. (Tab.2)

### Embodiment 2

In the embodiment 2 the two electrostatic capacitors are provided in tandem. The first capacitor is an energy filter and the second one images to the output plane in such a way that it compensates for the energy dispersion of the first capacitor. Embodiment 2 depicts the two identical hemispherical capacitor analysers in tandem each of them having a section with the spherically symmetric field and a sector of a field free region where a particle travels in a straight line. These two sectors fill into an angle of 180 degrees.

Imaging properties of this analyser are given by the relationship between the coordinate at the output plane in terms of input coordinates x,y,a,b and e at the first object plane, x is the half height of the object in the in the direction of the energy dispersion (across the equipotential surface of the electrostatic capacitor and perpendicular to the optical axis), y in the direction perpendicular to it as measured to the optical axis. The parameters a,b are the angles of the trajectory to the optical axis in the direction of x and y respectively, e is the particle energy spread in the units of the pass energy Ep (i.e. energy of a particle travelling along the curved optical axis through the condenser with no deviation)

$$X 3 = {\sum }_{□ = □}^{□} {D}_{i} {X}_{i} + {\sum }_{□ = □}^{□} {D}_{ij} {X}_{i} {X}_{j} + {\sum }_{□ = □}^{□} {D}_{ijk} {X}_{i} {X}_{j} {X}_{k}$$

where Xi in the above equation represents any of the five variables x,y,a,b,e. Below are the most important coefficients for the dispersive direction x as a function of the sector angle Q of the sector occupied by the field free region.

$$Dx = 1$$

$$Da = 0$$

$$De = 0$$

$$Daa = 0$$

$$Dxa = - 2 Sin [ 2 Q ]$$

$$Dxx = - 2 {Sin [ 2 Q ]}^{2}$$

$$Dxe = 4 Cos [ 2 Q ] {Sin [ Q ]}^{2}$$

$$Dae = - 4 {Sin [ Q ] }^{2} Tan [ Q ]$$

$$Dee = 8 {Sin [ Q ]}^{4}$$

$$Daaa = 12 ( 3 + 2 Cos [ 2 Q ] ) {Tan [ Q ]}^{3}$$

$$Dxxx = - 6 ( - 1 + 2 Cos [ 2 Q ] + Cos [ 4 Q ] ) {Sin [ 2 Q ]}^{2}$$

$$Daee = - 4 ( - 3 + Cos [ 2 Q ] ) {Sin [ Q ]}^{2} Tan [ Q ]$$

$$Dxxa = - \frac{1}{2} Sec [ Q ] ( - 22 Sin [ Q ] + 5 Sin [ 3 Q ] + 3 Sin [ 5 Q ] )$$

$$Dxxe = 2 ( - 1 + 8 Cos [ 2 Q ] + 3 Cos [ 4 Q ] ) {Sin [ Q ] }^{2}$$

$$Dxae = - 4 ( 4 + Cos [ 2 Q ] ) {Sin [ Q ] }^{2} Tan [ Q ]$$

$$Dxee = - 2 ( - 5 + 6 Cos [ 2 Q ] + 3 Cos [ 4 Q ] ) {Sin [ Q ] }^{2}$$

TABLE
Imaging properties of a capacitor with a spherically symmetric field representing the Embodiment 2.
Field free Sector Angle

| Q | Dx | Da | De | Daa | Dxx | Dxa | Dxe | Dae | Dee | Dxxx | Dxxa | Dxxe | Daax | Daaa | Daae | Dxee | Daee | Deee |
|---|---|---|---|---|---|---|---|---|---|---|---|---|---|---|---|---|---|---|
| 45 | 1.00 | 0.00 | 0.00 | 0.00 | −2.00 | −2.00 | 0.00 | −2.00 | 2.00 | 6.00 | 10.00 | −4.00 | 14.00 | 36.00 | −14.00 | 8.00 | 6.00 | −6.00 |
| 30 | 1.00 | 0.00 | 0.00 | 0.00 | −1.50 | −1.73 | 0.50 | −0.58 | 0.50 | 0.75 | 2.60 | 0.75 | 3.00 | 9.25 | −3.00 | 1.75 | 1.45 | −2.25 |

In the table are the the aberration coefficients in the image equation which describes the image coordinate ×3 as a function of the position ×1, angle a1 of the deviation from the optical axis, e being the energy spread . The ×3, ×10 In the relative units of the radius of curvature of the optical axis, the energy spread is in the units of the kinetic energy of a paritcle travelling along the curved optical axis. ×3 = Dx*X1 + Da*a1 + De*e + Dxx*X1\hat{ }2 + Daa*a1\hat{ }2 + Dxa*X1*a1 + Dxe*X1*e + Dae*a1*e + Dee*e\hat{ }2 + Dxxx*X1\hat{ }3 + Dxxa*X1\hat{ }2*a1 + etc third order terms

Because of the mirror symmetry the device has the magnification D× of 1 and as Da=De=Daa=0 the device focuses to the second order in angle and energy. The most significant term for Q>0 is Dxa which can be compensated by tilting the image plane. Significant is also that for optical axes 90 degrees to each other Q=π/4 and Dxe=0

Also the effects of these terms on the analyser imaging reduces with the angles of deviation reduce.

As is seen from the Embodiment 1 the best microscopic performance is achieved if we place at least two lenses between the sample and the first image plane of the analyser where the first lens closer to the sample has magnification of about 3 and the second lens has magnifications of 200, The angle restricting aperture of the lens 2 placed in the vicinity of its focal plane acts as a restricting aperture for the energy selection. For the near axial particle trajectories with angle of deviation to the optical axis in the order of 0.02 radians and lens focal distances of the order of 4 mm the disc for restricting the angles at the focal plane of the first lens is 0.08 mm which is reduced at the focal plane of the second by factor of 3 to 0.03 . . . This is the effective size of the slit for the energy selection for the analyser.

The input angle into the energy selecting part of the analyser is given by the half width of the image of the sampling area divided by the distance between the first and the second object planes.

The image half width of the sample area is is the half width of the sample area (0.02 mm) magnified by the lenses by approx 200× to give an image of +−4 mm image at the image plane 1. the distance between the first and the second object planes is approx 400 mm so the angle deviation of the beams for the energy selection is 0.01 rad. This gives energy spread under 1 eV with analyser pass energies 1000 eV for the microscopy the relative energy spread for the image focussing is e/Eo<0.001

This gives aberration disks of the order of 100 nm for the microscope with the initial energy of the particles of 1000 eV and sample at the ground potential.

### Embodiment 3

The construction of a particle spectrometer with field equipotential surfaces in the form of a Torus or a spheroid
FIG. 5b, show the construction where a sector field of the analyzer is of a torroidal or spheroidal type. A toroidal surface is created when a circle with radius R is rotated around an axis (called a y-axis) and a distance Ra from the centre point of the circle to the axis of rotation.

The shape of an electrostatic field between two such surfaces created by rotating two circles with radii R1, R2 with a common axis create toroidal equipotential surfaces. One such surface between the two electrodes is taken as a reference. With Circle radius Rc, the circle distance Ra) to the axis of rotation we define a reference distance R0=Rc+Ra0 Which corresponds to the radius of the central trajectory. A particle travelling on this trajectory remains on an equipotential surface has a reference energy E0. A particle having an energy E is referred as E=E0*(1+e) and e is the relative energy deviation. We define a coordinate system in which z-axis is along the circle of the central trajectory, x axis is in the direction of the radius vector on the central trajectory and the y-axis is in the direction perpendicular to it x-direction runs across the equipotential surfaces the y axis along the surface.

Similarly, a spheroidal surface is created by rotating an ellipse around an axis going through the middle of the ellipse coinciding with one of the axes. The same definitions apply to it as above.
Referring to FIG. 5b, electrons emitted by an sample object and is imaged at the entrance aperture 43, which has the distance L1 from the field entry at 9a at the top of the plate 10. According to the definitions in claim 1 this aperture lies at the first object plane of the imaging analyser. Mono energetic particles coming from this plane are imaged at the plane of a detector 22, distance L1′ from the sector field exit at the top of the plate 10. The particle beams go through an aperture 44 at the cross-over point of some lens system which lies at the distance L2 to the entrance 39 to the electrostatic sector is imaged at the plane 16 which lies at the distance L2′ from the electrostatic sector exit plane. According to the above definitions this aperture is placed at the second object plane of the analyser and together with the slits at the second image plane 42 forms a set of energy selecting slits as in the embodiments 1 and 2.

Because of the time reversal symmetry L1′=L2 and L2′=L1. imaging properties of this sector field are given by the image equation that binds the output parameters u,v, with the input parameters x,y. u,v are distances from the optical axis in the directions across and along the equl-potential surface respectively. This corresponds to the directions of energy dispersion and non-dispersion respectively. Parameters a,b give the corresponding angles of deviations from the optical axis in the two directions.

$$\begin{matrix}u = {\sum }_{i}^{ } {D}_{xi} * {X}_{i} + {\sum }_{i , j}^{ } {D}_{xixj} * {X}_{i} * {X}_{j} \\ v = {\sum }_{i}^{ } {D}_{xi} * {X}_{i} + {\sum }_{i , j}^{ } {D}_{xixj} * {X}_{i} * {X}_{j} \\ ⋮\end{matrix} \qquad ( 3.1 . )$$

Where Xi, Xj represents input coordinates x or y or a or b. or e. The coefficients of the first order such as magnifications Dx,Dy, the energy dispersion De, focal lengths L1,L2, and the second order coefficients Dxi,xj are displayed in the Tab3.a. in terms of the field parameters c, c′. Coefficient c is defined above and is together with c′ the coefficient of the expansion of the axial radius R(x) of the curvature of the equipotential surface at a small distance x from the central surface with the radius of curvature R0

R0/R(x)=c+c′*(x/R0)+second order terms (3.2)

A preferred geometry and the object and image parameters are depicted in Tab. 3b.

TABLE 3b
Preferred construction for the toroidal field of Embodiment 3
Coefficients of the imaging aberration for the toroidal type electrostatic field.
Coefficients of the imaging aberration for the dispersive direction

| c | L1 | L2 | C′ | Da | Daa | Dx | De | Dxx | Dax | Dxe | Cae | Cee | Cyy | Cyb |
|---|---|---|---|---|---|---|---|---|---|---|---|---|---|---|
| 1.702 | 1.006 | 2.42 | −9.14 | 0 | −1.83 | −1.45 | 8.23 | 0.47 | 2.06 | 5.28 | 34.7 | 40 | −1.1 | −0.78 |

Coefficients of the imaging aberration for the non-dispersive direction

| | | | | | | | | | |
|---|---|---|---|---|---|---|---|---|---|
| c | Db | Dbb | Dy | Dxy | Day | Dye | Dbe | Dxb | Dba |
| 1.702 | 0 | −1.83 | 2.01 | 0.99 | 7.07 | −0.74 | −4.78 | 3.34 | 11.54 |

It shows the energy dispersion De over 4× larger than for the case of the hemispherical analyser. That means that the device can have RO 4× smaller or the input aperture 4× bigger for the same energy resolution as for the case of the hemispherical sector. Da,Db corresponds to the case in which focus is brought at the same distance at both x- and y- directions. A difference in the absolute values of the first order magnifications Dx,Dy shows some distortion of the image in x with respect to y directions but this can be accommodated in the computer procedure for the evaluation of images.

1.-28. (canceled)

29. A particle spectrometer, operable to produce an image of a particle from an emitting or transmitting surface comprising
a means for causing particles to be emitted from the surface and/or transmitted through the surface;
a means for limiting the particles according to predetermined analysis criteria (e.g. range of energies, velocities or masses);
an electromagnetic imaging analyser comprising;
a selection means for selecting the particles for transmission into said spectrometer, said selection may be dependent on their electrostatic charge or magnetic moment, where the said analyser comprising;
an electromagnetic field is organised to focus at least a part of the bundle of the particles, thereby causing a particle imaging between different places of the analyser, the analyser further comprising of at least two pairs of object and image planes, wherein
a first pair, (21),(26) of the minimum two pairs of object and image planes relates to a detector, which images particle distributions according to the said analysis criteria;
a second pair (5),(18) of said at least two pairs of object and image planes, where restrictive means may be placed, that select particles, according to the said analysis criteria, this being a set of particles with selected range of energies, velocities, or masses;
further wherein the electromagnetic field and the means of the particle restriction are configured in such a way, that
at least one of the restrictive means connected with the second pair of planes may be substantially free of any electrostatic field; and
where the first pair of object and image planes may be either substantially free of the electrostatic field or the first pair of object and image planes may be at the border between the electrostatic field and the field free region.

30. A particle spectrometer according to claim 29, whereby said electromagnetic imaging analyser is capable of producing at least one image of said surface, wherein each image is tuned to a selected energy range and wherein any plurality of such images are produced simultaneously.

31. A particle spectrometer according to claim 29, wherein two of said electromagnetic imaging analysers can be attached in series thereby compensating for aberrations of said image;
where for the sector field analyser, the composite sector angle is >=180 degrees angle.

32. A spectrometer as claimed in claim 29, further comprising means for calculating each position of the particle corresponding to a selected area of said emitting or transmitting surface from an image derived from a detector, wherein each pixel, which is the smallest area of resolution of the detector surface, being connected to the analysis criteria may provide a photo-emission spectrum, or a mass spectrum of emitted particles according to these criteria.

33. A spectrometer as claimed in claim 29, further comprising means of displaying Images of the emitting surface whereby one or more recorded images of the emitting surface taken at different analysis criteria value (e.g. different energies or masses) may be manipulated by a computer program to remove background effects due to scattered secondary particles to recover for each pixel an intensity value corresponding to only an excitation effect, to provide 4-dimensional information, two dimensions may be the coordinates of the sample surface, the third dimension may be the energy or mass or velocity of the particle and the fourth dimension may be the intensity corresponding to the excitation effect of the spectrometer, within the following preferred disciplines of X-ray Photoemission (XPS), Auger emission(AES), Ion surface scattering emission (ISS), or secondary ion mass emission (SIMS).

34. A spectrometer as claimed in any of claims 29, further comprising a transfer electromagnetic lens system and an input lens, wherein said transfer electromagnetic lens system is positioned to receive an image of said surface by said input lens onto one of said object planes of said analyser.

35. A particle Spectrometer according to claim 34, may further be comprising a preferred embodiment where a near vertical excitation from a near horizontal sample surface, that then may create a near vertical particle beam bundle that passes into an input lens whereby the optical axis of the particle beam at the exit of the imaging electromagnetic field analyser, is near horizontal, within +/−30 degrees range of the acute angle to the horizontal axis.

36. A spectrometer as claimed in claim 34, wherein said transfer lens may have a magnification of at least 10 times and the overall magnification of the spectrometer may be adjustable in the range between 40 and 10000.

37. A spectrometer as claimed in any one of the claim 29, further comprising of a means of restricting the particles emitted from the sample surface to enter the said energy analyser with a predetermined solid angle and/or a predetermined field of view of the sample surface.

38. A spectrometer as claimed in any of the claim 29, further comprising of a set of retractable apertures placed in, or be conjugate with said image plane of said second pair of object and image planes of said analyser where these apertures may be kept on a voltage potential such that the moving parts of the retractable apertures may be kept in a region where electrostatic fields are negligible or sufficiently small not to disturb properties of the spectrometer.

39. A spectrometer as claimed in any of the claim 29, further comprising of a retractable slit mechanism, at said first object plane of one of said pair of object and image planes of said analyser, that has an adjustable slit width and a slit length, which may be used to determine an area of analysis of the emitting or transmitting surface, whereby moving parts are kept free of electrostatic fields.

40. A spectrometer as claimed in the claim 39, wherein said slit mechanism is shaped to restrict at least some of the imaging aberrations of said energy analyser of said spectrometer, and an acceptance angle of said particles into said analyser.

41. A spectrometer as claimed in any of the claim 29, further comprising a two-dimensional particle detector placed in, or conjugate with said first image plane of one of said pair of object and image planes of said analyser receiving one image or a plurality of simultaneous images of said surface, from the said limited emitted particles, where each image corresponds to a predetermined range of values according to the analysis criteria.

42. A method of operating the spectrometer of the claim 29, with a part of the said emitting or transmitting surface restricted for analysis, focusing properties of the spectrometer manipulated, using the slit mechanism and the retractable apertures, with a processed said image at the two-dimensional particle detector, such that each pixel, the smallest resolved co-ordinate, of the image at the particle detector, may include the direction of the emission and according to the analysis criteria, in addition to the 2 dimensions of the direction of the emission of the particles coming from substantially reduced part of the emitting or transmitting surface, to create a distribution of signal intensity across the particle detector that may represent the distribution of the particles according to the direction of the emission, according to the analysis criteria.

43. A particle Spectrometer according to claim 29, further comprising a detector capable of recording signal at a selected time of particle arrival at the detector and simultaneously capable of producing a set of images of said sample surface derived from particles coming from that surface, so as to recover a secondary ion mass spectrum from each point of at least a part of said surface dependent on a record of data produced at said detector.

44. A particle spectrometer according to claim 29 wherein said electromagnetic imaging analyser includes any one of an energy sector field analyser, an energy sector analyser, an energy filter, an analyser or an energy filter analyser.
